(19) United States
(12) Patent Application Publication
(10) Pub. No.: US 2023/0033039 A1
(43) Pub. Date: Feb. 2, 2023

(54) INFERENCE DEVICE, NON-TRANSITORY COMPUTER-READABLE STORAGE MEDIUM, AND INFERENCE METHOD

(71) Applicant: MITSUBISHI ELECTRIC CORPORATION, Tokyo (JP)

(72) Inventors: Kumiko IKEDA, Tokyo (JP); Koji TANAKA, Tokyo (JP); Yusuke KOJI, Tokyo (JP); Katsuki KOBAYASHI, Tokyo (JP)

(73) Assignee: MITSUBISHI ELECTRIC CORPORATION, Tokyo (JP)

(21) Appl. No.: 17/965,324

(22) Filed: Oct. 13, 2022

Related U.S. Application Data
(63) Continuation of application No. PCT/JP2020/021109, filed on May 28, 2020.

(51) Int. Cl. G06N 5/04

(52) U.S. Cl. CPC G06N 5/04

(57) ABSTRACT

An inference device includes a knowledge base unit that stores a knowledge base for inferring answers to requests; an information acquisition unit that acquires situation information that is information including a user request or a request from a user and response information including a user's response to an inference result or a result of inference; an inference unit that uses the knowledge base to make inferences for a user request included in the situation information; an information output unit that outputs an inference result; a feedback information extraction unit that specifies a desired result or a result desired by the user for the user request from the response information; and an update unit that updates the knowledge base such that the desired result more likely matches the inference result.

### CROSS-REFERENCE TO RELATED APPLICATION

This application is a continuation application of International Application No. PCT/JP2020/021109 having an international filing date of May 28, 2020.

### BACKGROUND OF THE INVENTION

### 1. Field of the Invention

The disclosure relates to an inference device, a non-transitory computer-readable storage medium, and an inference method.

### 2. Description of the Related Art

Devices have been widespread that operate through dialogic interaction with users, such as car navigation systems, home appliances, and smart speakers equipped with interactive human-machine interfaces (HMI). To implement the dialogic interaction function, it is necessary to design a statechart or a flowchart, etc., in accordance with a dialogic interaction scenario, but it is difficult to design a complex and diverse dialogic interaction or a dialogic interaction that comes across as thoughtful.

For conventional inference devices, there is a technique for dialogic interaction by inference based on a knowledge graph, which is a knowledge expression that graphically represents the attributes, relations, causal relations, etc., of events. For example, a technique is known in which the importance of each node in a knowledge graph is calculated starting from an inference start node representing an observed event, the node having high importance is acquired as an inference result, and the inference result is used for selecting a dialogic interaction scenario. In the past, the knowledge graph start node (refer to, for example, Patent Literature 1).
Patent Literature 1: JP 6567218 B

In the inference according to the conventional technique, inference processing is performed depending on the selection of the source node and the structure of the graph; thus, the conventional inference does not necessarily guarantee a desirable inference result. In the conventional technique, if a user behaves differently from the inference result when a certain inference result is presented, such behavior is not reflected in the knowledge graph. Thus, the conventional technique has a problem in that the same inference is made in similar situations, and hence an inference result desired by the user is not presented.

Therefore, an object of one or more aspects of the disclosure is to obtain an inference result that is desirable for a user by updating a knowledge base in consideration of the user's response to an inference result.

### SUMMARY OF THE INVENTION

An inference device includes: an auxiliary storage device to store a knowledge base for inferring an answer to a request; a processor to execute a program; and a memory to store the program which, when executed by the processor, preforms processes of, acquiring situation information and response information, the situation information being information including a user request, the user request being a request from a user, the response information including a response of the user to an inference result, the inference result being a result of an inference; making the inference for the user request included in the situation information by using the knowledge base; outputting the inference result; specifying a desired result from the response information, the desired result being a result desired by the user for the user request; and updating the knowledge base such that the desired result more likely matches the inference result. The processor assigns the user request to be an inference start node in nodes included in a knowledge graph specified by the knowledge base, calculates, starting from the inference start node, page rank values corresponding to arrival probabilities in a random walk on the knowledge graph, to calculate the importance of the nodes, specifies the node having the highest importance as an inference result node, and determines information indicated by the inference result node to be the inference result.

A non-transitory computer-readable storage medium storing a program that causes a computer to execute processing, the processing includes: acquiring situation information, the situation information being information including a user request, the user request being a request from a user; making an inference for the user request included in the situation information by using a knowledge base for inferring an answer to a request;

outputting an inference result, the inference result being a result of an inference; acquiring response information including a response of the user to the inference result; specifying a desired result from the response information, the desired result being a result desired by the user for the user request; and updating the knowledge base such that the desired result more likely matches the inference result. The computer assigns the user request to be an inference start node in nodes included in a knowledge graph specified by the knowledge base, calculates, starting from the inference start node, page rank values corresponding to arrival probabilities in a random walk on the knowledge graph, to calculate the importance of the nodes, specifies the node having the highest importance as an inference result node, and determines information indicated by the inference result node to be the inference result.

An inference method includes: acquiring situation information, the situation information being information including a user request, the user request being a request from a user; making an inference for the user request included in the situation information by using a knowledge base for inferring an answer to a request; outputting an inference result, the inference result being a result of an inference; acquiring response information including a response of the user to the inference result; specifying a desired result from the response information, the desired result being a result desired by the user for the user request; and updating the knowledge base such that the desired result more likely matches the inference result. In making the inference, the user request is assigned to be an inference start node in nodes included in a knowledge graph specified by the knowledge base, page rank values corresponding to arrival probabilities in a random walk on the knowledge graph is calculated to calculate the importance of the nodes, the node having the highest importance is specified as an inference result node, and information indicated by the inference result node is determined to be the inference result.

According to one or more aspects of the disclosure, an inference result that is desirable for a user can be obtained by updating a knowledge base in consideration of the user's response to an inference result.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a block diagram schematically illustrating the configuration of an inference system including an inference device according to a first embodiment;

FIG. 2 is a block diagram illustrating a hardware configuration example of an inference device;

FIG. 3 is a flowchart illustrating a knowledge base update process by the inference device according to the first embodiment;

FIG. 4 is a schematic diagram illustrating a first specific example of the knowledge base update process according to the first embodiment;

FIG. 5 is a schematic diagram illustrating a second specific example of the knowledge base update process according to the first embodiment;

FIG. 6 is a block diagram schematically illustrating the configuration of an inference system including an inference device according to a second embodiment;

FIG. 7 is a flowchart illustrating a knowledge base update process by the inference device according to the second embodiment; and

FIG. 8 is a schematic diagram illustrating a specific example of the knowledge base update process according to the second embodiment.

### DETAILED DESCRIPTION OF THE INVENTION

### First Embodiment

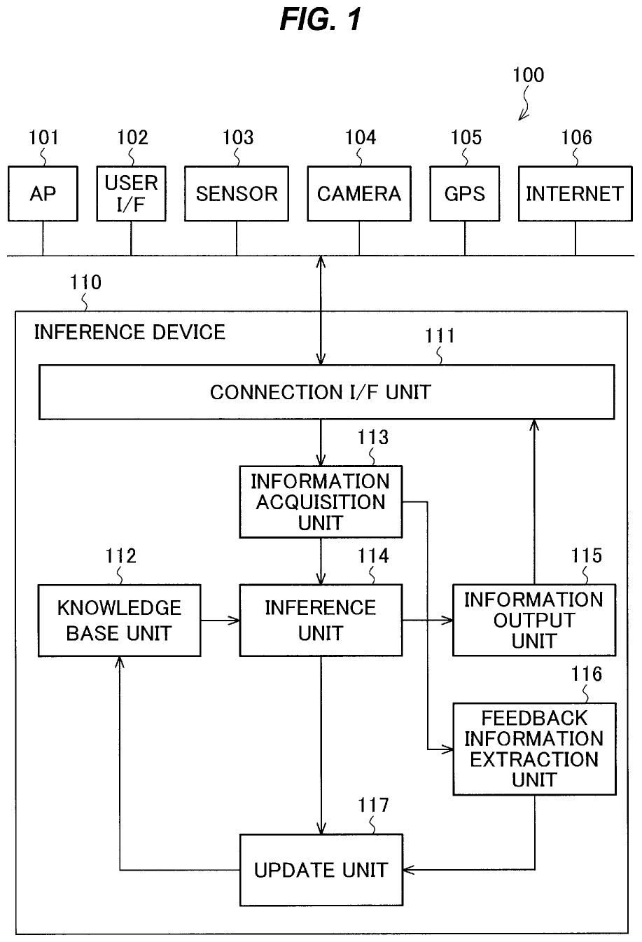

FIG. 1 is a block diagram schematically illustrating the configuration of an inference system 100 including an inference device 110 according to the first embodiment.

The inference system 100 is configured by connecting the inference device 110 to other devices such as an application (AP) 101, a user interface (user I/F) 102, a sensor 103, a camera 104, a global positioning system (GPS) 105, and the Internet 106.

The other devices to which the inference device 110 is connected are illustrative and may be any devices that output the inference results of the inference device 110 to users and receive responses to the inference results. In other words, the inference device 110 is connected to a user-side device capable of outputting inference results to users and receiving the responses to the inference results.

The inference device 110 includes a connection interface unit (connection I/F unit) 111, a knowledge base unit 112, an information acquisition unit 113, an inference unit 114, an information output unit 115, a feedback information extraction unit 116, and an update unit 117.

The connection I/F unit 111 is connected to and communicates with the user-side device.

The knowledge base unit 112 stores a knowledge base consisting of knowledge information. For example, the knowledge base is information for inferring answers to requests. Specifically, the knowledge base consists of information necessary for generating a knowledge graph, which is a figure having, as components, vertices (i.e., nodes) and sides (i.e., edges).

In the first embodiment, the inference device 110 includes the knowledge base unit 112, but the first embodiment is not limited to this example. For example, the knowledge base unit 112 may be provided in another device (e.g., a server such as a knowledge base server) that can be connected through the connection I/F unit 111.

The information acquisition unit 113 acquires various pieces of information from the user-side device via the connection I/F unit 111. For example, the information acquisition unit 113 acquires situation information including a user request, which is information including a request from a user, and response information including a user's response to the inference result. The situation information and the response information are acquired from the user's environment, etc. The situation information is given to the inference unit 114, and the response information is given to the feedback information extraction unit 116.

The inference unit 114 performs inference from the situation information received from the information acquisition unit 113 by using the knowledge base stored in the knowledge base unit 112. The inference unit 114 then gives the result of this inference or the inference result to the information output unit 115.

For example, the inference unit 114 uses the knowledge base to make an inference for a user request, which is a request from a user, included in the situation information.

In the first embodiment, the inference unit 114 specifies an inference start node or a start node from the situation information and performs inference through a method such as page rank calculation for retrieving the shortest path from the inference start node.

Specifically, the inference unit 114 assigns a user request to be an inference start node in nodes included in a knowledge graph specified by a knowledge base, and calculates, starting from the inference start node, the page rank values corresponding to the arrival probabilities of the respective nodes in a random walk on the knowledge graph, to calculate the importance of the nodes. The inference unit 114 then specifies the node having the highest calculated importance as the inference result node and determines the information indicated by the inference result node to be the inference result.

The information output unit 115 outputs the inference result received from the inference unit 114 to the user-side device via the connection I/F unit 111.

To enable the extraction of feedback information, the information output unit 115 may also output candidates besides the inference result from the history or the like at the time of output of the inference result, to allow the user to select the desired result. The result may be given as response information from the information acquisition unit 113 to the feedback information extraction unit 116. Alternatively, the user may input the result desired by voice when the inference result does not coincide with the user's intent.

After the information output unit 115 has output the inference result, the feedback information extraction unit 116 acquires the response information of the user from the information acquisition unit 113. The feedback information extraction unit 116 then specifies, on the basis of the response information, the desired result, which is the result desired by the user to be obtained for the user request, from the user's response to the inference result, and extracts the feedback information indicating the desired result. The extracted feedback information is given to the update unit 117.

The feedback information extraction unit 116 functions as a desired result specifying unit that specifies a desired result from the response information.

For example, the feedback information indicates the inference result when the inference result matches the result desired by the user, and indicates the result desired by the user when the inference result does not match the result desired by the user. The feedback information extraction unit 116 determines, for example, whether or not the response from the user to the information output unit 115 matches the inference result. When the user's response does not match the inference result, the feedback information extraction unit 116 specifies the result desired by the user on the basis of the response from the user.

Alternatively, for the result desired by the user, information may be preset in the feedback information extraction unit 116, and when the response information includes the preset information, the feedback information extraction unit 116 may specify this information as to be the result desired by the user.

The update unit 117 updates the knowledge base stored in the knowledge base unit 112 by using the situation information received from the information acquisition unit 113, the inference result received from the inference unit 114, and the feedback information received from the feedback information extraction unit 116.

For example, the update unit 117 updates the knowledge base so that the desired result is more likely to be the inference result.

Specifically, when the inference result is different from the desired result, the update unit 117 downweights the edges included in the shortest path between the inference start node and the inference result node in the knowledge graph indicated by the knowledge base. Moreover, the update unit 117 upweights the edges included in the shortest path between the inference start node and the node corresponding to the desired result in the knowledge graph.

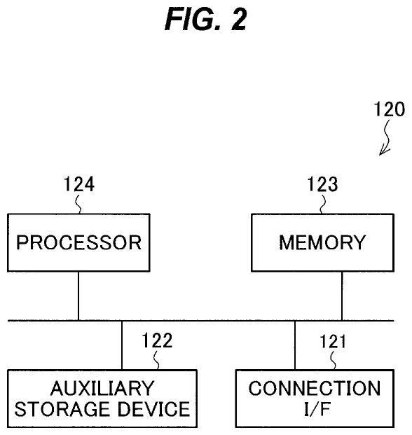

FIG. 2 is a block diagram illustrating a hardware configuration example of the inference device 110.

The inference device 110 can be implemented by a computer 120 including a connection interface (connection I/F) 121, an auxiliary storage device 122, a memory 123, and a processor 124.

For example, the information acquisition unit 113, the inference unit 114, the information output unit 115, the feedback information extraction unit 116, and the update unit 117 can be implemented by the processor 124 loading programs stored in the auxiliary storage device 122 to the memory 123 and executing these programs. These programs can be provided by a non-transitory computer-readable storage medium storing them.

The connection I/F unit 111 can be implemented by the connection I/F 121 used by the processor 124.

The knowledge base unit 112 can be implemented by the auxiliary storage device 122 used by the processor 124.

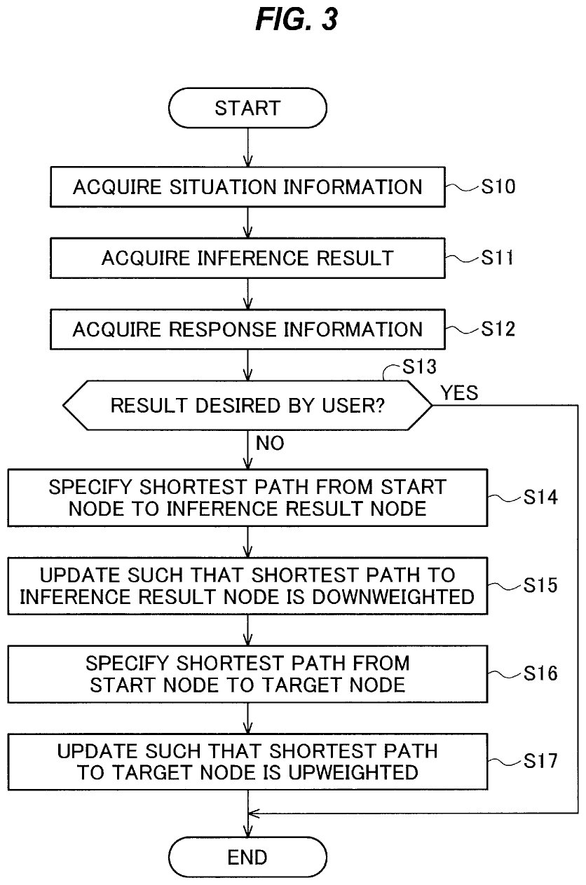

FIG. 3 is a flowchart illustrating a knowledge base update process in the inference device 110 according to the first embodiment.

First, the update unit 117 receives situation information from the information acquisition unit 113 (step S10). The update unit 117 then specifies the information serving as an inference start node from the situation information. For example, the update unit 117 preliminarily determines information that can be an inference start node, and when the situation information includes such information, the update unit 117 specifies this information as an inference start node.

The update unit 117 then receives the inference result from the inference unit 114 (step S11). The update unit 117 then specifies the information included in the inference result as the inference result node.

The update unit 117 then receives feedback information from the feedback information extraction unit 116 (step S12). The update unit 117 then specifies the information included in the feedback information as a target node.

The update unit 117 then determines whether or not the inference result from the inference unit 114 is the result desired by the user (step S13). For example, the update unit 117 determines that the inference result is the result desired by the user when the inference result node matches the target node, and determines that the inference result is not the result desired by the user when the inference result node does not match the target node. If the inference result is the result desired by the user (Yes in step S13), the update unit 117 does not update the knowledge base, and the process ends. If the inference result is not the result desired by the user (No in step S13), the process proceeds to step S14.

In step S14, the update unit 117 specifies the shortest path from the inference start node to the inference result node.

The update unit 117 then downweights the edges of the shortest path specified in step S14 (step S15). For example, the update unit 117 downweights the edges by a predetermined value.

The update unit 117 then specifies the shortest path from the inference start node to the target node (step S16).

The update unit 117 then upweights the edges of the shortest path specified in step S16 (step S17). For example, the update unit 117 upweights the edges by a predetermined value.

As described above, according to the flowchart illustrated in FIG. 3, if the inference result does not match the result desired by the user, the path used in the inference can be downweighted to make it difficult to produce such a result. In contrast, by upweighting the path that obtains the result desired by the user, the result desired by the user can readily obtained as the inference result.

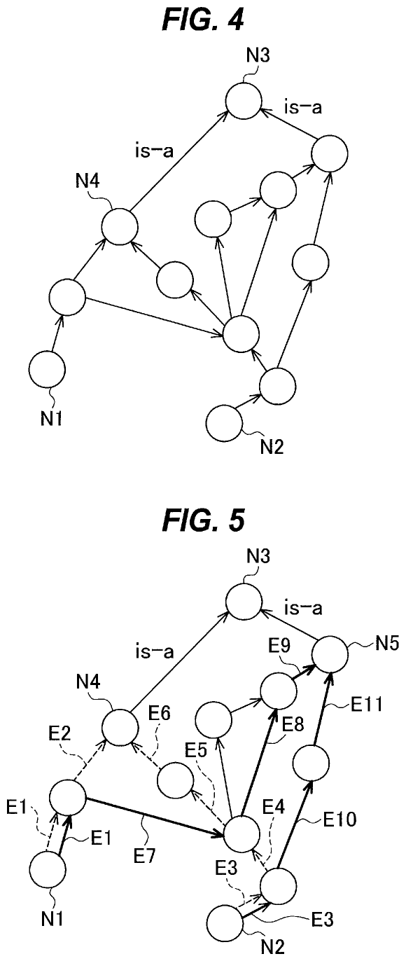

A specific example of the knowledge base update process will now be described with reference to FIGS. 4 and 5.

FIGS. 4 and 5 are examples of a recommendation system for suggesting a restaurant that is recommended for a driver driving an automobile. FIGS. 4 and 5 illustrate a case in which a hamburger shop is proposed in response to an input of current time information (for example, Friday evening).

In the case of a knowledge graph such as that illustrated in FIG. 4, the reference sign N1 indicates a “Friday” node serving as an inference start node, and the reference sign N2 indicates an “evening” node serving as an inference start node.

The inference unit 114 assigns the “Friday” node N1 and the “evening” node N2 for the calculation of the page rank value of each node. The inference unit 114 then determines the inference result to be the “hamburger” node N4 having the largest page rank value out of nodes connected to the “restaurant” node N3 through the “is-a” edges. Thus, the information output unit 115 outputs information recommending a “hamburger” shop as a restaurant to the user-side device via the connection I/F unit 111.

However, if the user responds, for example, “I want to eat ramen rather than hamburger” via the user-side device, the update unit 117 specifies from the feedback information that the result desired by the user is “ramen.”

Since the result desired by the user indicated in the feedback information does not match the inference result, the update unit 117 downweights the edges E1 and E2 included in the shortest path between the “Friday” node N1, which is an inference start node, and the “hamburger” node N4, which is the inference result, and downweights the edges E3, E4, E5, and E6 included in the shortest path between the “evening” node N2, which is an inference start node, and the “hamburger” node N4, which is the inference result, as illustrated in FIG. 5.

On the other hand, the update unit 117 upweights the edges E1, E7, E8, and E9 included in the shortest path between the “Friday” node N1, which is an inference start node, and the “ramen” node N5, which is the result desired by the user, and upweights the edges E3, E10, and E11 included in the shortest path between the “evening” node N2, which is an inference start node, and the “ramen” node N5, which is the result desired by the user.

As described above, by changing the weights of the edges of the knowledge base used for the inference, the inference result desired by the user is more likely to be produced.

In the first embodiment, if the result desired by the user is produced in step S13 of the flowchart illustrated in FIG. 3, the update unit 117 does not update the knowledge base; however, the first embodiment is not limited to such an example.

For example, even in such a case, the update unit 117 may obtain the shortest path from an inference start node to the inference result node, and upweight the edges on the path to make it easier to produce the output result.

### Second Embodiment

In the first embodiment, the result desired by the user is specified from the feedback information, and update is performed, but in the second embodiment, the result desired by the user and a factor for selecting the result are specified from the response information indicating a response from the user, and update is performed. Note that the response information according to the second embodiment includes information for specifying a factor.

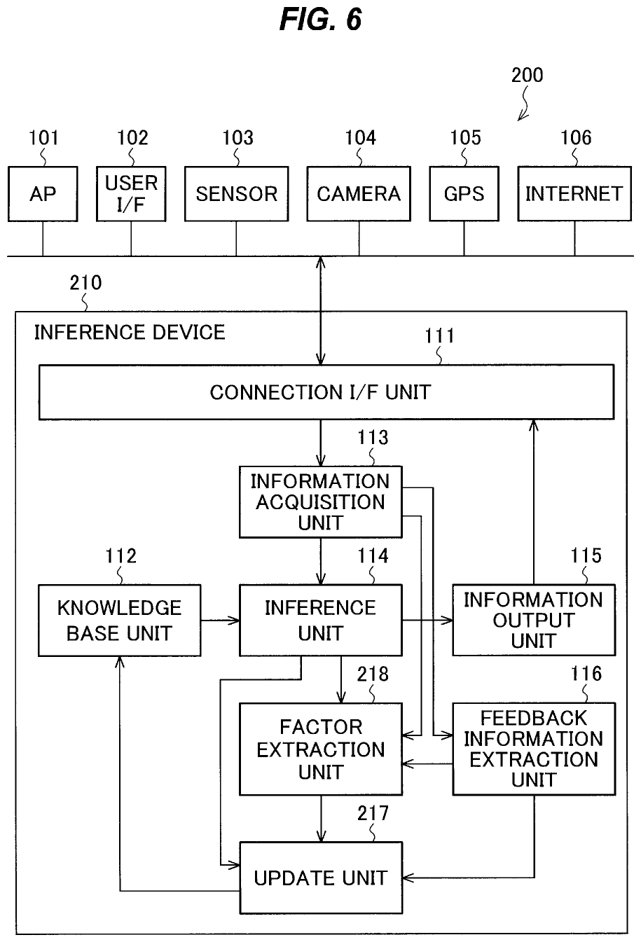

FIG. 6 is a block diagram schematically illustrating the configuration of an inference system 200 including an inference device 210 according to the second embodiment.

The inference system 200 is configured by connecting the inference device 210 to other devices such as an AP 101, a user I/F 102, a sensor 103, a camera 104, a GPS 105, and the Internet 106.

The other devices such as the AP 101, the user I/F 102, the sensor 103, the camera 104, the GPS 105, and the Internet 106 of the inference system 200 according to the second embodiment are respectively the same as the other devices such as the AP 101, the user I/F 102, the sensor 103, the camera 104, the GPS 105, and the Internet 106 of the inference system 100 according to the first embodiment.

The inference device 210 includes a connection I/F unit 111, a knowledge base unit 112, an information acquisition unit 113, an inference unit 114, an information output unit 115, a feedback information extraction unit 116, an update unit 217, and a factor extraction unit 218.

The connection I/F unit 111, the knowledge base unit 112, the information acquisition unit 113, the inference unit 114, the information output unit 115, and the feedback information extraction unit 116 of the inference device 210 according to the second embodiment are respectively the same as the connection I/F unit 111, the knowledge base unit 112, the inference unit 114, the information output unit 115, and the feedback information extraction unit 116 of the inference device 110 according to the first embodiment.

However, the information acquisition unit 113 also gives the response information to the factor extraction unit 218; the inference unit 114 also gives the inference result to the factor extraction unit 218; and the feedback information extraction unit 116 also gives the feedback information to the factor extraction unit 218.

When the inference result is determined not to be the result desired by the user on the basis of the inference result from the inference unit 114 and the feedback information from the feedback information extraction unit 116, the factor extraction unit 218 specifies the factor causing the result desired by the user from the response information from the information acquisition unit 113 and extracts the factor information indicating the specified factor. The factor information is given to the update unit 217.

For the factor causing the result desired by the user, if information is preset in the factor extraction unit 218, and the preset information is included in the response information, the factor extraction unit 218 specifies this information as the factor causing the result desired by the user.

The factor extraction unit 218 functions as a factor specifying unit for specifying the factor causing the desired result from the response information.

The information output unit 115 may communicate with the user when the inference result is output, to extract the factor. For example, the information output unit 115 may receive a response from the user after the result desired by the user has been selected by the user's response to the presented inference result, to obtain the reason why the result was selected.

Since the feedback information is the same type of data as the inference result, the factor extraction unit 218 may determine, to be the factor, the information of a type different from that of the inference result from the responses from the user.

The update unit 217 updates the knowledge base stored in the knowledge base unit 112 by using the situation information received from the information acquisition unit 113, the inference result received from the inference unit 114, the feedback information received from the feedback information extraction unit 116, and the factor indicated by the factor information received from the factor extraction unit 218.

Specifically, when the inference result is different from the desired result, the update unit 217 downweights the edges included in the shortest path between an inference start node and the inference result node passing through the factor node, which is the node indicating the factor indicated by the factor information, in the knowledge graph indicated by the knowledge base. On the other hand, the update unit 217 upweights the edges included in the shortest path between the inference start node and the node corresponding to the desired result passing through the factor node.

The inference device 210 according to the second embodiment can also be implemented by the computer 120 illustrated in FIG. 2.

For example, the update unit 217 and the factor extraction unit 218 can be implemented by the processor 124 loading programs stored in the auxiliary storage device 122 to the memory 123 and executing the programs.

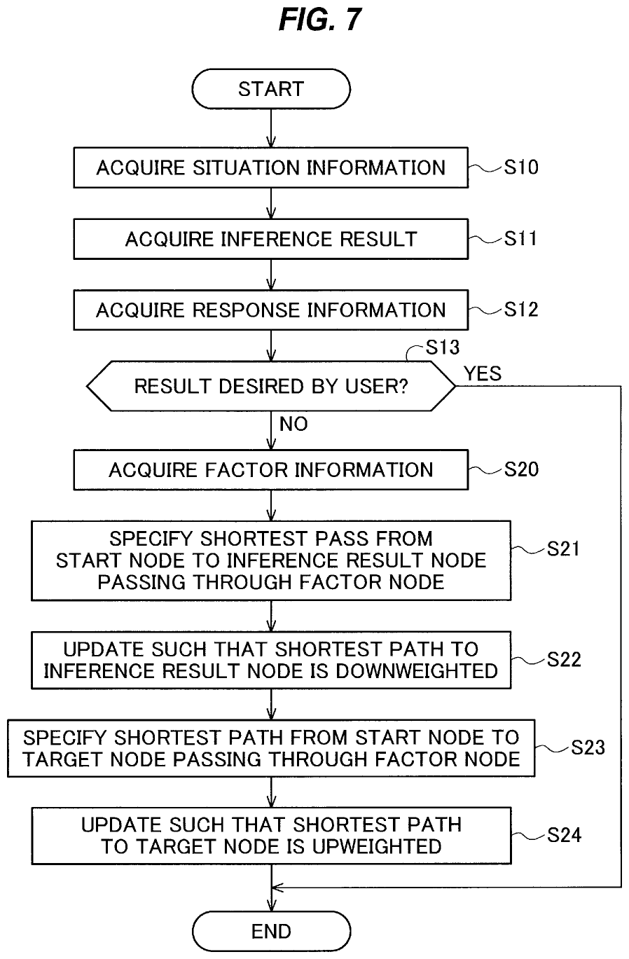

FIG. 7 is a flowchart illustrating a knowledge base update process by the inference device 210 according to the second embodiment.

Among the steps included in the flowchart illustrated in FIG. 7, the steps that are the same as those in FIG. 3 are denoted by the same reference signs as those in FIG. 3.

The processing of steps S10 to S13 in FIG. 7 are the same as the processing of steps S10 to S13, respectively, in FIG. 3.

In step S13, if the inference result is not the result desired by the user (No in step S13), the process proceeds to step S20.

In step S20, the update unit 217 acquires the factor information from the factor extraction unit 218.

The update unit 217 then specifies the shortest path from the inference start node to the inference result node passing through the factor node corresponding to the factor indicated by the factor information (step S21).

The update unit 217 then downweights the edges of the shortest path specified in step S21 (step S22). For example, the update unit 217 downweights the edges by a predetermined value.

The update unit 217 then specifies the shortest path from the inference start node to the target node passing through the factor node (step S23).

The update unit 217 then upweights the edges of the shortest path specified in step S23 (step S24). For example, the update unit 217 upweights the edges by a predetermined value.

If none of the paths pass through the factor node in step S21, the update unit 217 may acquire a path having a section where the path from the factor node to the target node overlaps the path from the inference start node to the target node.

If none of the paths pass through the factor node in step S23, the update unit 217 may acquire a path having a section where the path from the factor node to the inference result node overlaps the path from the inference start node to the inference result node.

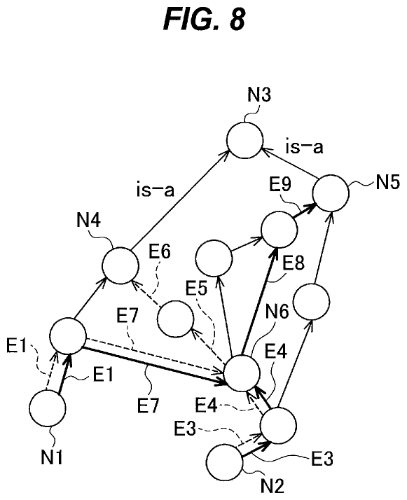

A specific example of the update process of the knowledge base will now be described with reference to FIG. 8.

FIG. 8 is an example of a recommendation system for suggesting a restaurant that is recommended to a driver driving an automobile, as in the first embodiment illustrated in FIGS. 4 and 5.

For example, as in the first embodiment, when the inference result is “hamburger,” and the user responds, “I want to eat ramen rather than a hamburger” after the result “hamburger” is presented, the feedback information indicates “ramen.” It is then presumed that the user responds, “I prefer ramen when it is cold,” to the question “Ramen is also a good choice. Do you prefer ramen because it is cold?”

In such a case, the inference start nodes are the “Friday” node N1 and the “evening” node N2; the inference result node is the “hamburger” node N4; and the target node is the “ramen” node N5.

The factor node is the “cold day” node N6.

In such a case, the update unit 217 downweights the edges E1, E7, E5, and E6 included in the shortest path between the “Friday” node N1, which is an inference start node, and the “hamburger” node N4, which is the inference result, passing through the “cold day” node N6, which is the factor node, and downweights the edges E3, E4, E5, and E6 included in the shortest path between the “evening” node N2, which is an inference start node, and the “hamburger” node N4, which is the inference result, passing through the “cold day” node N6, which is the factor node.

On the other hand, the update unit 217 upweights the edges E1, E7, E8, and E9 included in the shortest path between the “Friday” node N1, which is an inference start node, and the “ramen” node N5, which is the result desired by the user, passing through the “cold day” node N6, which is the factor node, and upweights the edges E3, E4, E8, and E9 included in the shortest path between the “evening” node N2, which is an inference start node, and the “ramen” node N5, which is the result desired by the user, passing through the “cold day” node N6, which is the factor node.

Alternatively, instead of the “cold day” node, the factor node may be a node indicating “a temperature of 10 degrees or less” based on the temperature acquired by the sensor 103. Alternatively, if the response information includes yesterday's behavior history such as “I had this yesterday,” the factor node may be a node indicating the history “I had this yesterday.”

Thus, by upweighting the path including the factor node during inference, the result desired by the user can be inferred with higher accuracy in a situation including the factor node.

### DESCRIPTION OF REFERENCE CHARACTERS

100, 200 inference system; 101 AP; 102 user I/F; 103 sensor; 104 camera; 105 GPS; 106 Internet; 110, 210 inference device; 111 connection I/F unit; 112 knowledge base unit; 113 information acquisition unit; 114 inference unit; 115 information output unit; 116 feedback information extraction unit; 117, 217 update unit; 218 factor extraction unit.

What is claimed is:

1. An inference device comprising:
an auxiliary storage device to store a knowledge base for inferring an answer to a request;
a processor to execute a program; and
a memory to store the program which, when executed by the processor, preforms processes of,
acquiring situation information and response information, the situation information being information including a user request, the user request being a request from a user, the response information including a response of the user to an inference result, the inference result being a result of an inference;
making the inference for the user request included in the situation information by using the knowledge base;
outputting the inference result;
specifying a desired result from the response information, the desired result being a result desired by the user for the user request; and
updating the knowledge base such that the desired result more likely matches the inference result,
wherein the processor assigns the user request to be an inference start node in nodes included in a knowledge graph specified by the knowledge base, calculates, starting from the inference start node, page rank values corresponding to arrival probabilities in a random walk on the knowledge graph, to calculate the importance of the nodes, specifies the node having the highest importance as an inference result node, and determines information indicated by the inference result node to be the inference result.

2. The inference device according to claim 1, wherein, when the inference result is different from the desired result, the processor downweights edges included in a shortest path between the inference start node and the inference result node and upweights edges included in the shortest path between the inference start node and a node corresponding to the desired result, in the knowledge graph.

3. The inference device according to claim 1, wherein
the processor specifies a factor causing the desired result from the response information and updates the knowledge base by using the factor.

4. The inference device according to claim 3, wherein, when the inference result is different from the desired result, the processor downweights edges included in a shortest path between the inference start node and the inference result node passing through a factor node and upweights edges included in the shortest path between the inference start node and a node corresponding to the desired result passing through the factor node, in the knowledge graph, the factor node being a node indicating the factor.

5. A non-transitory computer-readable storage medium storing a program that causes a computer to execute processing, the processing comprising:
acquiring situation information, the situation information being information including a user request, the user request being a request from a user;
making an inference for the user request included in the situation information by using a knowledge base for inferring an answer to a request;
outputting an inference result, the inference result being a result of an inference;
acquiring response information including a response of the user to the inference result;
specifying a desired result from the response information, the desired result being a result desired by the user for the user request; and
updating the knowledge base such that the desired result more likely matches the inference result,
wherein the computer assigns the user request to be an inference start node in nodes included in a knowledge graph specified by the knowledge base, calculates, starting from the inference start node, page rank values corresponding to arrival probabilities in a random walk on the knowledge graph, to calculate the importance of the nodes, specifies the node having the highest importance as an inference result node, and determines information indicated by the inference result node to be the inference result.

6. An inference method comprising:
acquiring situation information, the situation information being information including a user request, the user request being a request from a user;
making an inference for the user request included in the situation information by using a knowledge base for inferring an answer to a request;
outputting an inference result, the inference result being a result of an inference;
acquiring response information including a response of the user to the inference result;
specifying a desired result from the response information, the desired result being a result desired by the user for the user request; and
updating the knowledge base such that the desired result more likely matches the inference result,
wherein, in making the inference, the user request is assigned to be an inference start node in nodes included in a knowledge graph specified by the knowledge base, page rank values corresponding to arrival probabilities in a random walk on the knowledge graph is calculated to calculate the importance of the nodes, the node having the highest importance is specified as an inference result node, and information indicated by the inference result node is determined to be the inference result.
